(19) United States
(12) Patent Application Publication
(10) Pub. No.: US 2016/0270301 A1
(43) Pub. Date: Sep. 22, 2016

(54) MACHETE

(71) Applicant: Estwing Manufacturing Company, Inc., Rockford, IL (US)

(72) Inventors: Joshua D. West, Rockford, IL (US); Robert H. Youngren, Stillman Valley, IL (US); John W. Ryan, JR., Belvidere, IL (US); Mark Youngren, Oregon, IL (US)

(21) Appl. No.: 14/662,507

(22) Filed: Mar. 19, 2015

(51) Int. Cl. A01G 3/08

(52) U.S. Cl. CPC A01G 3/083

(57) ABSTRACT

Cutting tools are disclosed herein that include a handle, a hilt, and a blade that may be monolithic.

### CROSS REFERENCE TO RELATED APPLICATIONS

Not applicable

### REFERENCE REGARDING FEDERALLY SPONSORED RESEARCH OR DEVELOPMENT

Not applicable

### SEQUENCE LISTING

Not applicable

### BACKGROUND OF THE INVENTION

1. Field of the Background

The present invention relates generally to cutting tools, and more specifically, to machetes designed for repeated use and multiple tasks.

2. Description of the Background

A woodsman, hunter, outdoorsman, or soldier requires several tools when in the field. These tools may include one or more knives, an axe, a hatchet, and/or a saw, depending on the terrain in which the individual is operating. Often, the individual must carry each of these tools into the field, which is difficult due to their weight, size, and number. Moreover, there may be times when the individual must switch tools which necessitates storing a first tool and accessing a second tool or risk misplacing the first tool if not immediately stored.

In an attempt to overcome such problems, numerous iterations of combination tools have been designed. For example, a combination hand axe and saw includes an elongated handle provided at one end with a hand grip. The handle and the hand grip have a continuous groove, and a saw blade positioned in the groove, the saw blade being pivoted to the handle near the outer end thereof. The saw blade, when in an operative position, has its free end positioned in the groove in the hand grip, the groove in the hand grip being curved about the pivot of the saw, and a stop for limiting the outward movement of the saw in the hand grip groove. The saw blade is foldable into the groove in the handle so as to be entirely within the outlines thereof. The tool further includes means for latching the blade in both its operative and inoperative positions.

Another example is a combination cutting tool that includes a knife and a saw blade. The cutting tool has a handle that is formed of two side plates which serve as the main structural support for the knife assembly. The side plates are bolted to the blade portion and may be pivoted to an approximate 45° angle to serve as a handle for the saw blade.

Other examples of combination tools combine knife and/or machete blades with a removable saw blade that is riveted, bolted, or otherwise reversibly affixed to the knife/machete blade. However, combination tools, such as those described above, tend to suffer from being poorly designed and inadequately durable to withstand repeated use. Further, some of these tools require some manipulation and/or assembly before they may be used in all manners intended.

There is a need, therefore, for a bladed hand tool that can be used for cutting, chopping, and sawing that overcomes the shortcomings of the prior art by providing multiple blade features and durable construction to withstand heavy repeated use.

### SUMMARY OF THE INVENTION

According to one aspect, a cutting tool includes a handle, a hilt, and a blade including a saw blade and a cutting blade. The handle, hilt, and blade are monolithic.

According to another aspect, a cutting tool includes a handle, a hilt, a blade, and a first primary fillet disposed on a first side of the blade and a second primary fillet disposed on a second side of the blade. Each primary fillet is disposed at an intersection of the blade and the hilt.

According to a further aspect, a cutting tool includes a handle, a hilt, a blade including a saw blade and a cutting blade. The cutting tool includes a first primary fillet disposed on a first side of the blade and a second primary fillet disposed on a second side of the blade. Each primary fillet is disposed at an intersection of the blade and the hilt.

### BRIEF DESCRIPTION OF THE DRAWINGS

Other aspects and advantages of the present invention will become apparent upon reading the following detailed description and upon reference to the drawings in which:

FIG. 1 is an isometric view of a front, left, and top side of a machete according to one embodiment;

FIG. 2 is a partial left side elevational view of the machete of FIG. 1;

FIG. 3 is a partial right side elevational view of the machete of FIG. 1;

FIG. 4 is a partial top plan view of the machete of FIG. 1;

FIG. 5 is a front elevational view of the machete of FIG. 1;

FIG. 6 is a partial rear elevational view of the machete of FIG. 1;

FIG. 7 is a partial cross-sectional rear view of a machete according to another embodiment;

FIG. 8 is a photograph comparing a machete according to the present disclosure (top) to a prior art machete with a bolt-on handle (bottom);

FIG. 9 is a close up view of the prior art machete of FIG. 8; and

FIG. 10 is another close up view of the prior art machete of FIG. 8 illustrating the inner construction of the bolt-on handle.

### DETAILED DESCRIPTION OF THE INVENTION

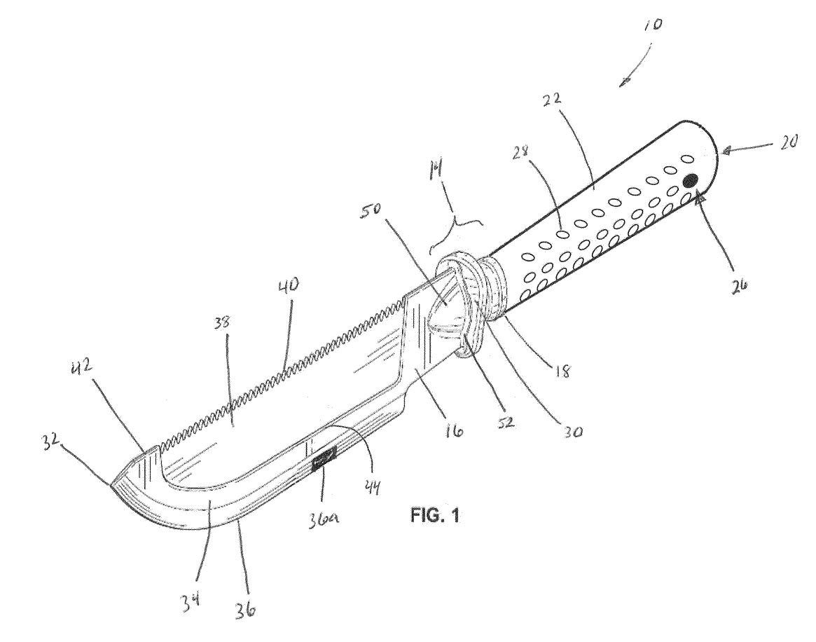

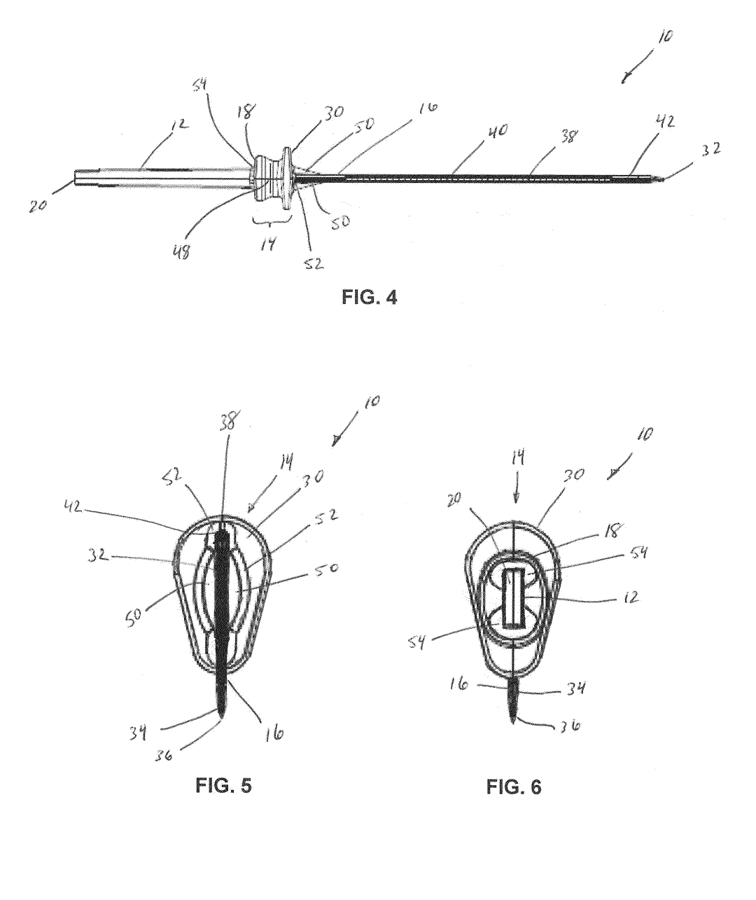

As depicted in FIGS. 1-7, a machete 10 of the present disclosure generally includes a handle 12, a hilt 14, and a blade 16. In one preferred embodiment, the handle 12, hilt 14, and blade 16 are monolithic, that is, formed of a single, integral piece of material, such as steel, a metal alloy, a composite material, and/or combinations thereof. In this way, the handle 12, the hilt 14, and the blade 16 of the machete 10 may have a contiguous, unbroken construction to provide greater strength and durability to the machete.

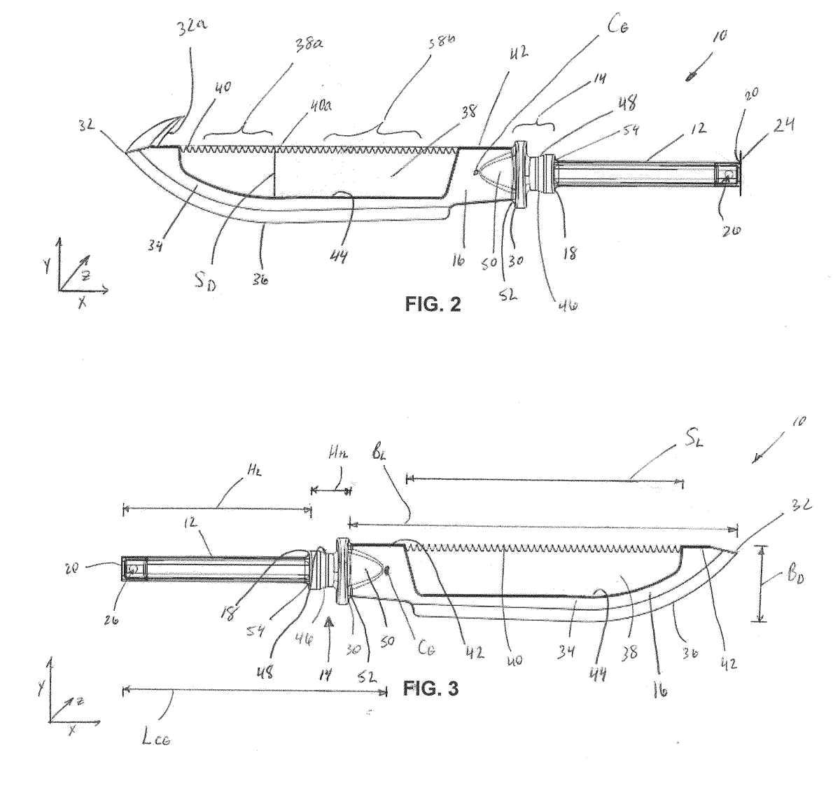

The handle 12 extends from a bottom end 18 of the hilt 14 to an end portion 20 of the handle. The bottom end 18 may serve as a dam for injection molding of a grip 22 disposed on the handle 12 when the grip is made at least in part from a moldable material. Alternatively, the bottom end 18 may be used as a stop when the grip 22 is assembled from plastic, rubber, and or leather ringlets that may be threaded onto the handle 12. The grip 22 may extend from the bottom end 18 to cover the end portion 20 of the handle 12, such as when the grip includes a moldable material, or may stop at an end plate 24 (see FIG. 2). The end plate 24 may be integral with the handle 12 or may be added subsequently once the handle and/or grip 22 is formed to provide structural support for the grip. An aperture 26 may extend through the grip 22 and the handle 12 near the end portion 20 of the handle to allow a cord, rope, lanyard, or other device to pass therethrough and be securely attached to the machete 10. Further, the grip 22 may include one or more surface features 28, such as surface irregularities, indicia, icons, divots, treads, bumps, and combinations thereof to improve a user's ability to securely grasp the machete 10 without slippage.

The blade 16 extends from a top end 30 of the hilt 14 to a blade tip 32, which may be pointed, blunt, rounded, or have any other desired shape. Further, the blade tip 32 may include a feature such as a gut hook 32a, as seen in FIG. 2, or similar to those, for example, disclosed in U.S. Pat. Nos. 6,658,743, 5,359,778, and D392,016. The blade 16 may include a cutting blade 34 having a sharpened or partially sharpened cutting edge 36. Further, it is envisioned that the cutting blade 34 may have any shape. For example, the cutting blade 34 when viewed from the side, in profile, may be straight, wavy, concave, convex (as seen in FIGS. 1-3), angled, kukri-shaped, scimitar-shaped, sabre-shaped, and combinations thereof. Further, the cutting edge 36 may include a portion 36a (see FIG. 1) that is textured differently from the remaining portion of the blade. For example, the portion 36a may be serrated, scalloped, wavy, or include texturing or another feature that facilitates cutting, whereas the remaining portion of the cutting edge 36 may be straight or curved. The portion 36a may extend the entirety of the length of the cutting edge 36, or may extend about ⅘, about ¾, about ⅔, about ½, about ¼, about ⅛, or about 1/10 of the length of the cutting edge.

The blade 16 may further include a saw blade 38 having a plurality of saw teeth 40 opposite of the cutting edge 36 along a spine 42 of the blade. The saw teeth 40 may be of any desired size to enable a user to cut metal, wood, bone, and the like. In one embodiment, the machete 10 may include a saw blade 38 having saw teeth 40 of multiple sizes. For example, as seen in FIG. 2, the saw blade 38 may include a first portion 38a with saw teeth 40 of a first size (for example, saw teeth suitable for cutting wood) and a second portion 38b with saw teeth of a second, different size (for example, smaller saw teeth suitable for cutting metal). In another embodiment, the saw teeth 40 may all have the same height to form a cutting plane 40a or may have alternating heights in which situation the cutting plane is formed by the highest saw teeth. The saw teeth 40 may also be flared, such that every other saw tooth is angled in a direction opposite of its neighbors.

The saw blade 38 may have a length S_{L}, as seen in FIG. 3, that extends along the spine 42 at least a portion of the distance between the top end 30 of the hilt 14 and the blade tip 32. The length S_{L} may be about ⅕, or about ¼, or about ⅓, or about ½, or about ⅔, or about ¾ or about ⅘ the length of the blade 16. In another embodiment, the saw blade 38 may extend the entire length of the blade 16 from the top end 30 of the hilt 14 to the blade tip 32. In a further embodiment, when the saw blade 38 includes two portions 38a and 38b with different size saw teeth 40, the relative size of each portion with respect to the other may range from about 1:1 or about 1:2 or about 1:3 or about 1:5 the length S_{L}.

The overall length B_{L} of the blade 16 is measured from the top end 30 of the hilt 14 to the blade tip 32 and may be about 6 inches, or about 8 inches, or about 10 inches, or about 12 inches, or about 16 inches, or about 20 inches, or about 30 inches, or more. The handle 12 may have a length H_{L} measured from the bottom end 18 of the hilt 14 to the end portion 20 of the handle of about 4 inches, or about 5 inches, or about 6 inches, or about 8 inches, or about 12 inches. The hilt 14 may have a length Ht_{L} measured from the bottom end 18 of the hilt 14 to the top end 30 of the hilt ranging from about 1 inch to about 3 inches, or more.

In another embodiment, a ratio of the blade length B_{L} to the handle length H_{L} (B_{L}/H_{L}) may range from about 0.5 to about 10, or from about 1 to about 4, or about 1 to about 2, or may be about 0.5, or about 1, or about 1.5, or about 2, or about 3, or about 5.

Further, the saw blade 38 may have a depth S_{D} measured perpendicular to the cutting plane 40a to a back edge 44 of the cutting blade 34. The blade 16 may have an overall depth B_{D} measured perpendicular to the length B_{L} from the spine 42 to the cutting edge 36 of about 2 inches, or about 3 inches, or about 4 inches, or more. The depth S_{D} of the saw blade 38 may be about ¼, or about ½, or about ⅔, or about ¾ of the depth B_{D}.

In one embodiment, the saw blade 38 has a thickness (measured along the Z axis in FIG. 2) equal to that of the cutting blade 34. In another embodiment, the saw blade 38 has a thickness of about ⅘, or about ¾, or about ⅔, or about ½, or less, of the thickness of the cutting blade 34, which may be about ⅛ inch, or about ¼ inch, or about ⅜ inch, or about ½ inch, or about ⅝ inch, or about ¾ inch thick. A thicker cutting blade 34 makes the machete 10 better able to withstand repeated blows against hard objects, such as tree branches and the like, while a thinner saw blade 38 reduces the amount of effort required when using the saw blade to cut through an object. Further, using a thinner saw blade 38 allows the blade 16 to have substantial structural integrity while also reducing the overall weight of the machete 10.

In one embodiment, the cutting blade 34 and the saw blade 38 may be integral with one another as well as with the hilt 14 and the handle 12. In another embodiment, the cutting blade 34 may be integral with the hilt 14 and the handle 12, and the saw blade 38 may be replaceable. In this embodiment, the saw blade 38 may be attached to the cutting blade 34 by welding, an adhesive, friction fit, snap fit, a fastener, or other chemical and/or mechanical means. Further, in this embodiment, the saw blade 38 may be made of the same or a different material than the cutting blade 34.

As seen in FIGS. 2-4, the hilt 14 may include at least one of a finger notch 46 and a thumb notch 48 each of which is generally concave and disposed between the bottom end 18 and the top end 30 of the hilt. The finger notch 46 and thumb notch 48 are both formed to fit a user's index finger and thumb. In this way, the user may rotate the machete 10 in his grasp 180 degrees so that either the cutting blade 34 or the saw blade 38 faces away from the user and experience the same grip shape when holding the machete. The top end 30 of the hilt 14 may further serve as a finger guard.

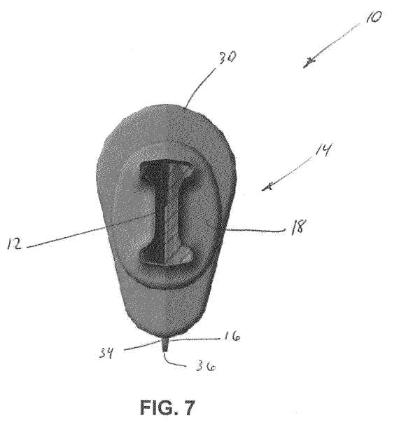

As seen best in FIGS. 3, 4, 6 and 7, the machete 10 may have a hilt 14 cross section measured perpendicular to the hilt length Ht_{L} at the bottom end 18 of the hilt and a handle 12 cross section measured along its length, such that the hilt cross section has an area greater than or equal to the handle cross section. In one embodiment seen in FIG. 7, the hilt cross section area may be about twice that of the handle 12, and the handle may have a generally hour-glass shaped cross-section, though any shape is contemplated.

The machete 10 further includes a primary fillet 50 disposed on either side of the blade 16 at the intersection of the blade and the hilt 14. The primary fillet 50 is generally wedge-shaped and is integral with both the blade 16 and the hilt 14. In one embodiment, the primary fillet 50 has a maximal length measured in parallel with the blade length B_{L} that is greater than, equal to, or shorter than a maximal width of the primary fillet measured perpendicularly to the blade length B_{L} adjacent the top end 30 of the hilt. The primary fillet 50 adds to the durability of the machete 10 in a number of ways. To begin with, the primary fillet 50 serves to transfer stress applied to the blade 16 to the hilt 14 more evenly, the result being a smaller stress riser occurring at the intersection of the blade and the hilt when a force is applied to the blade.

Secondary fillets 52 extend from a base of the primary fillets 50 nearest the hilt 14 to the top end 30 of the hilt. The secondary fillets 52 provide a secondary mode of stress transfer from the blade 16 to the hilt 14 to further reduce the size of the stress riser occurring at the intersection of the blade and the hilt when a force is applied to the blade. Tertiary fillets 54 extend from the bottom end 18 of the hilt 14 to the handle 12 and similarly function to more evenly transfer stress from the hilt to the handle when a force is applied to the blade 16 to reduce the size of the stress riser occurring at the intersection of the hilt and the handle. Thus, machetes 10 of the present disclosure may include a system of primary, secondary, and tertiary fillets 50, 52, and 54, respectively, (or more) that effectively transfer stress applied to the blade 16 through the hilt 14 and to the handle 12 to increase machete durability.

In some instances, it may be desirable to have a machete 10 with an increased or decreased blade weight relative to the handle weight to shift the machete's center of gravity (C_{G}) either toward the blade tip 32 or toward the end portion 20 of the handle 12. The center of gravity C_{G} may be shifted, for example, by altering blade length B_{L}, blade depth B_{D}, and/or blade thickness in combination with increasing or decreasing the thickness of the handle 12 and/or the hilt 14. The ability to vary the dimensions of the machete 10 offers the ability to easily alter the balance and weight of the tool itself during the design/manufacturing process. This approach allows for a single tool that may not only be weighted and balanced for specific tasks, but also for a wider range of tasks, wherein the machete 10 may be used for tasks suitable for a large knife or those suitable for a hatchet.

For example, a machete 10 according to the present disclosure that may be used for carving wood or clearing light weeds or brush may have a center of gravity C_{G} shifted toward the end portion 20 of the handle 12 to provide a lighter blade 16. In this example, the center of gravity C_{G} may be coincident with the bottom end 18 of the hilt 14 or closer to the end portion 20 of the handle 12. In contrast, a machete 10 intended to be used for clearing heavy brush, tree limbs, or small trees entirely, may have a heavier blade 16 with the center of gravity C_{G} shifted farther forward between the blade tip 32 and the primary fillet 50.

In one embodiment, a machete 10 according to the present disclosure may have an overall length (H_{L}+Ht_{L}+B_{L}) of approximately 19.25 inches. The center of gravity C_{G} may occur about 11 inches from the tip 32 and 8¼″ from the end portion 20 of the handle 12.

In another embodiment, a machete 10 according to the present disclosure may have an overall length (H_{L}+Ht_{L}+B_{L}) and a second length L_{CG} measured from the end portion 20 of the handle 12 to the center of gravity C_{G}. A ratio of the overall length to the second length may be greater than about 1 and less than about 6.

Machetes 10 of the present disclosure may have the handle 12, hilt 14, and blade 16 formed of metal, though any suitable material or combinations of materials may be used. Examples of materials that may be used for the different features of the machetes 10 contemplated herein, include metals, without limitation, polymers, plastics, composites, wood, carbon fiber, graphite, fiberglass, foam, rubber, leather, and combinations thereof. Specific metals contemplated include, among others, titanium, aluminum, steel, and alloys thereof. Further materials contemplated for use herein include polymers and metal alloys and superalloys suitable for additive manufacturing. A material may be selected, for example, based on its hardness, malleability, strength, density, and weight, among other factors.

The grip 22 may be made of any suitable material or combinations of materials, such as leather, plastic, rubber, wood, foam, an elastomeric material, a vibration reducing grip material, and combinations thereof. In one embodiment, the grip material may have a Shore A durometer of from about 40 to about 80, or about 50 to about 75, or about 63 to about 73, or about 60, or about 65, or about 68. Grip materials contemplated for use also include those disclosed in U.S. Pat. No. 6,465,535.

One contemplated process for manufacturing machetes 10 according the present disclosure is forging. The forging process results in a stronger product compared to stamped products when like materials and heat treating processes are used. Additionally, the forging process offers the ability to create significantly different thicknesses along the blade 16 and handle 12, where a stamping process is limited by the thickness of the sheet metal used. Forging also allows for a more consistent cross sectional area along the entire machete 10 promoting better balance and more uniform strength along the tool. Moreover, the ability to vary the thickness along the machete 10 via the forging process allows for an increased variety of ornamental designs where ribs, graphics, or lettering on the surface of the blade 16 may be embedded, raised, or both.

Another contemplated process for use in manufacturing cutting tools of the present disclosure includes folding materials to be incorporated into the cutting tools.

### Examples

It is a standard practice in the industry to manufacture knives and/or machetes with a stamped steel blade and a hilt made of another similar or dissimilar material that is mounted to a grip/handle by fasteners, such as screws or bolts. The hilts of these tools may become loose, however, if the grip weakens or separates from the handle. In addition, the point where the blade joins the hilt forms a sharp corner which creates a stress riser where the blade may fracture or break and separate from the handle where it meets the hilt. To compare the durability of a machete according to the present disclosure (test machete) against a commercially available (control) machete, the following test was performed.

The test and control machetes were approximately the same length and included similar features. However, the blade of the control machete was bolted to the hilt, and the tang passed through the hilt, but stopped at the top of the handle. Each machete was placed in a machine where the handle was secured to a swinging arm that swung the machete around a fixed axis of rotation in a chopping motion to strike a piece of hard wood. Each machete struck the wood approximately 28 inches from the axis of rotation traveling on an arc having a circumference of about 176 inches. Each swing of a machete started at a velocity of 0 and accelerated through 45 degrees of the arc before striking the wood under approximately 90 inch-pounds of torque. Additional characteristics of the machetes and test parameters are listed in Table No. 1 below.

TABLE NO. 1
Machete and Testing Parameters

| Parameter ^{a} | Control Machete | Test Machete |
|---|---|---|
| Weight (pounds) | 0.95 | 1.75 |
| Mass Moment (pound-inch-sec) | 0.96 | 1.77 |
| Acceleration (inches/sec²) | 93.4 | 50.7 |
| Final Velocity (inches/sec) | 64.1 | 47.2 |
| Force upon striking wood | 247.1 | 361.0 |
| (pounds)^{b} | | |

^{a} calculated values are approximate;
^{b}time of negative acceleration estimated at 0.25 sec.

The control machete failed after 1,450 blows when the handle separated from the hilt and blade. The test machete withstood 20,000 blows with no signs of fatigue at which point the machine was stopped.

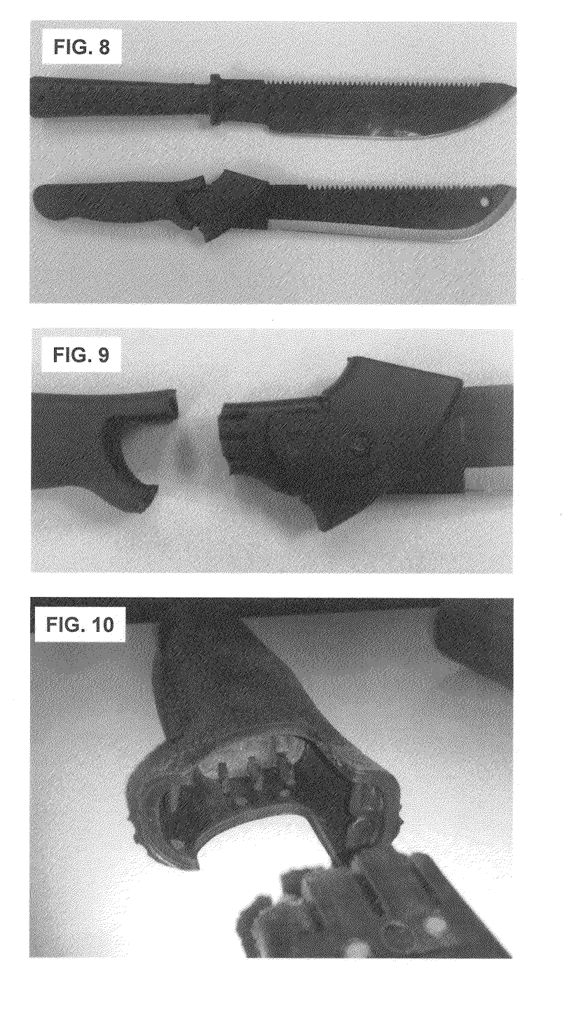

As seen in FIG. 8, the test machete (top) shows no sign of structural damage after the test. However, the control machete, seen in FIG. 8 (bottom) and in close up in FIGS. 9 and 10 failed at the junction between the handle and the hilt. Based on these results, machetes of the present disclosure are substantially more durable than machetes of the same or similar construction to the control machete. Moreover, machetes of the present disclosure are able to withstand more than 20,000 blows against hard wood when accelerated under 90 inch/pounds of torque without structural damage. These results further demonstrate the effective transfer of stress from the blade through the system of fillets to the handle to minimize the negative effects of stress risers.

### INDUSTRIAL APPLICABILITY

The cutting tools disclosed herein provide multiple blade features and durable construction that can withstand heavy repeated use.

Numerous modifications will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the application are reserved. All patents and publications are incorporated by reference. All values and ratios disclosed herein may vary by ±10%, ±20%, or ±40%.

We claim:

1. A cutting tool, comprising:
a handle;
a hilt; and
a blade comprising a saw blade and a cutting blade,
wherein the handle, hilt, and blade are monolithic.

2. The cutting tool of claim 1 further comprising a grip disposed on the handle.

3. The cutting tool of claim 2, wherein the grip comprises at least one surface feature.

4. The cutting tool of claim 1 further comprising an end plate disposed on the handle.

5. The cutting tool of claim 1 further comprising an aperture through the handle.

6. The cutting tool of claim 1, wherein the hilt comprises at least one of a finger notch and a thumb notch.

7. The cutting tool of claim 6, wherein the finger notch and the thumb notch are each formed to fit a user's index finger and thumb.

8. The cutting tool of claim 1, wherein the cutting blade comprises a cutting edge.

9. The cutting tool of claim 8, wherein the cutting edge comprises a first portion and a second portion.

10. The cutting tool of claim 9, wherein the first portion comprises at least one of a serrated edge, a scalloped edge, and a wavy edge and the second portion comprises a straight or curved edge.

11. The cutting tool of claim 1, wherein the saw blade has a thickness less than a thickness of the cutting blade.

12. The cutting tool of claim 11, wherein the saw blade comprises saw teeth, and wherein the saw teeth are flared.

13. A cutting tool, comprising:
a handle;
a hilt;
a blade; and
a first primary fillet disposed on a first side of the blade and a second primary fillet disposed on a second side of the blade, each primary fillet being disposed at an intersection of the blade and the hilt.

14. The cutting tool of claim 13 further comprising secondary fillets extending from a base of the first and second primary fillets to a top end of the hilt.

15. The cutting tool of claim 14 further comprising tertiary fillets extending from a bottom end of the hilt to the handle.

16. The machete of claim 15, wherein the handle, hilt, blade, first and second primary fillets, secondary fillets, and tertiary fillets are monolithic.

17. A cutting tool, comprising:
a handle;
a hilt;
a blade comprising a saw blade and a cutting blade; and
a first primary fillet disposed on a first side of the blade and a second primary fillet disposed on a second side of the blade, each primary fillet being disposed at an intersection of the blade and the hilt.

18. The cutting tool of claim 17, wherein the handle, hilt, blade, and first and second primary fillets are formed from a single, integral piece of material.

19. The cutting tool of claim 18, wherein each primary fillet has a maximal length greater than a maximal width.

20. The cutting tool of claim 17, wherein a ratio of an overall length of the cutting tool to a second length measured from an end portion of the handle to the center of gravity C_{G} of the cutting tool ranges from about 1 and to about 6.
